(19) United States
(12) Patent Application Publication
(10) Pub. No.: US 2006/0011132 A1
(43) Pub. Date: Jan. 19, 2006

(54) Apparatus for coating edible products with a fat-containing mass

(75) Inventors: Horst Haring, Derenburg (DE); Birk Hochapfel, Wernigerode (DE); Reiner Hochapfel, Wernigerode (DE)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: CHOCOTECH GmbH

(21) Appl. No.: 11/178,582

(22) Filed: Jul. 11, 2005

(30) Foreign Application Priority Data
Jul. 13, 2004 (DE) 10 2004 033 713.6

(51) Int. Cl. A01J 27/02; A23G 3/20; A21C 9/04

(52) U.S. Cl. 118/13; 118/20

(57) ABSTRACT

An apparatus (1) for coating edible products with a fat-containing coating mass includes a frame (3) including a plurality of spaced apart columns (4). The columns (4) are located in an outer portion of the apparatus (1), and they are approximately vertical. A grating belt (15) serves to transport the products placed thereon though the apparatus (1) in a working direction (2). A coating unit (10) directs the coating mass onto the products as they are transported on the grating belt (15) though the apparatus (1). A tub unit (6) includes a tub (7). The length (34) of the tub (7) in the working direction (2) is chosen such that essentially all surplus coating mass dripping down from the grating belt (15) is collected in the tub (7). The height (29) of the tub (7) is chosen such that the tub (7) fits below the grating belt (15). The tub (7) and the columns (4) are designed and arranged such that a distance (35) between the columns in the working direction (2) is greater than the length (34) of the tub (7) such that the tub (7) can be completely removed from the apparatus (1) in a lateral direction perpendicular to the working direction (2).

### CROSS REFERENCE TO RELATED APPLICATIONS

This application claims priority to co-pending German Patent Application No. DE 10 2004 033 713.6 entitled “Vorrichtung zum Überziehen von essbaren Produktstucken mit einer Kakaobutter oder ein sonstiges Feft enthaltenden Masse”, filed Jul. 13, 2004.

### FIELD OF THE INVENTION

The present invention generally relates to an apparatus for coating edible products with a fat-containing mass. For example, the products may be sweets to be coated with a chocolate mass containing cocoa butter.

Such an apparatus may also be called a coating machine, and it serves to apply a coating onto product pieces or articles of the food industry and sweets industry. Especially, such articles are chocolate bars, candy and the like. Usually, the mass is a chocolate mass. However, it is also possible to process other masses with the coating machine, such as other fat-containing masses, coating masses, caramel masses and the like.

The mass used for coating is taken from a tub, and it is conveyed into a rising tube by a pump. The rising tube ends in a coating unit which may be designed as a so called curtain box or a tube distributing unit. Due to gravity, the mass then freely falls and flows, respectively, down from the coating unit in the form of a curtain. During this downward movement of the mass, product pieces placed on a grating belt are conveyed through the apparatus in a horizontal direction and transverse to the curtain of coating mass to pass the curtain. In this way, the articles placed on the grating belt are coated with the mass. Surplus mass flows through the openings of the grating belt in a downward direction, and it is collected in the tub being located below the grating belt.

### BACKGROUND OF THE INVENTION

An apparatus for coating edible products with a fat-containing mass is known from German Patent No. DE 42 43 814 C1 corresponding to U.S. Pat. No. 5,437,723. The known apparatus includes a frame which is designed to be stiffened in a way similar to a grid. The frame includes columns which substantially extend in a vertical direction. Usually, the frame at least in its lower portion is covered such that the columns are arranged in the inside of the covering elements and of the apparatus, respectively. A tub is arranged within the frame and between the columns, respectively, in a stationary manner. The tub includes a declined drainage surface. A pump is located at the lowest location of the tub. The pump sucks in the mass, and it transfers the mass into a rising tube. The rising tube ends in a coating unit. A grating belt is arranged between the coating unit and the tub. The upper portion of the grating belt is designed to be horizontal and to convey the product pieces through the apparatus. The grating belt especially in its lower portion is guided by a plurality of tensioning rollers and deflecting rollers. Additional deflecting rollers are located at the entrance and at the exit of the grating belt in the apparatus. These deflecting rollers have a comparatively small diameter to make sure that the product pieces are received from and delivered to the preceding and following belts, respectively. It is also possible to arrange a bottoming unit in the region of the grating belt to coat the bottom surfaces of the product pieces. Often, a vibrating or shaking apparatus is associated with the grating belt. Detailer shafts or other shafts or rollers may be associated with the deflecting roller of the grating belt located at the exit side of the apparatus. The components of the grating belt—meaning the grating belt itself including protrusions, the deflecting rollers as well as the remaining elements associated with the grating belt—get in contact with the coating mass such that the mass builds up at these elements to a certain extent. During normal operation of the apparatus and due to temperatures then prevailing at these elements, surplus mass drips down from these elements, and it is collected in the tub.

Supply elements and control elements for electric power are arranged in a unit located in the upper portion of the known apparatus. The respective drives of the apparatus are controlled by these control elements. Often, one or more fans are also located in this unit. The fans are associated with nozzles facing the surface of the grating belt. In this way, air is blown through the nozzles onto the freshly coated product pieces placed on the grating belt to even out the coating of the articles and to reduce its thickness.

For hygiene reasons, it is necessary to clean such an apparatus, and to preferably remove all coating mass from the apparatus. In case of changing the mass, for example from a dark chocolate mass to a white chocolate mass, it is also necessary to discharge the apparatus and to clean its components. Furthermore, the grating belt is subject to wear and tear. Consequently, the grating belt needs to be repaired or replaced within certain time intervals. All these operations can be conducted in the known apparatus. However, these operations are aggravated since assembly of the single elements of the apparatus has resulted in one single fixed unit. There only is little space between the elements such that it is difficult to access the elements. This applies to repairing and maintenance services as well as to services required when changing the coating mass and the like.

Another apparatus for coating edible product pieces with a fat-containing mass is known from German utility model (“Gebrauchsmuster”) No. DE 87 04 693 U1. The known apparatus includes a housing in which important elements of the coating machine are arranged. The housing includes an inlet opening and an outlet opening being connected by a driven grating belt. The housing may be carried by a frame having a three-dimensional design and including vertical columns. The columns are arranged in a way to face the inside of the apparatus. The apparatus also includes a bottom coating unit below which a reservoir and feeding apparatus is arranged to be removed in a lateral direction. For this purpose, a plurality of conduits including quick acting closing connections has to be detached. The reservoir and feeding apparatus has a length in the working direction of the apparatus (i.e. the direction of movement of the grating belt through the apparatus) which is substantially smaller than the length of the grating belt. In this way, the reservoir and feeding apparatus including declined drainage plates is not capable of collecting the entire surplus coating mass dripping down from the grating belt.

Another coating machine is known in the art. The known coating machine serves for processing comparatively small amounts of coating mass. The known apparatus includes a frame. The frame includes struts, it has a cube-like design and it is covered at the relevant locations such that the vertical columns of the frame are located in the inside of the apparatus. The apparatus includes a tub being arranged on rails such that it may be removed from below the apparatus on these rails in a lateral direction. The tub may be moved from below the apparatus to a limited extent until it contacts stop elements. In other words, the tub cannot be completely removed from the apparatus. Thus, even in the outermost position, the partly removed tub has a negative effect on accessibility of the grating belt located in the apparatus. The grating belt can only be accessed from the other side of the apparatus. The rising tube includes a plurality of sections. Each section is supported at the faces of the grating belt in a stationary way, and it includes two quick acting closing connections of which the lower one has to be detached when the tub is to be moved from below the apparatus against the stop elements in a lateral direction. Remainders of the mass being located in the rising tube can then drip down into the tub when the tub is located in the partly removed position. The length of the tub extending in the working direction is substantially smaller than the length of the grating belt. Consequently, declined drainage plates are arranged at the apparatus. These drainage plates are not removed from below the apparatus. However, they also need to be cleaned. Thus, the partly removable tub acting against stop elements has to be cleaned in place. It is not possible to completely remove the tub from the apparatus, and to transport it to a location where it could be cleaned in an easier and more effective way. It is not possible to easily replace the tub, for example by using a different tub for a different coating mass. Mass dripping down from the coating unit reaches the ground when the tub is partly removed such that it is necessary to additionally clean the ground. All these facts make it complicated, time consuming and expensive to clean the known apparatus. It is not possible to fulfill respectively increased hygiene requirements.

All the above described known apparatuses as well as other known apparatuses including fixedly mounted tubs can only be cleaned in place. For this purpose, it is also known to flood the entire apparatus. Flooding is a different possibility of fulfilling hygiene requirements.

### SUMMARY OF THE INVENTION

The present invention relates to an apparatus for coating edible products with a fat-containing coating mass. The apparatus includes a frame including a plurality of spaced apart columns. The columns are located in an outer portion of the apparatus, and they are designed and arranged to be approximately vertical. A grating belt is designed and arranged to transport the products placed thereon though the apparatus in a working direction. A coating unit is designed and arranged such that the coating mass is directed onto the products as they are transported on the grating belt though the apparatus. A tub unit includes a tub having a length in the working direction and a height. The length of the tub is chosen such that essentially all surplus coating mass dripping down from the grating belt is collected in the tub. The height of the tub is chosen such that the tub fits below the grating belt. The tub and the columns are designed and arranged such that a distance between the columns in the working direction is greater than the length of the tub such that the tub can be completely removed from the apparatus in a lateral direction perpendicular to the working direction.

With the novel apparatus, it is possible to easily access all desired elements of the apparatus for purposes of maintenance and cleaning, for example. The required cleaning and resetting period of times of the apparatus are reduced.

Elements of the apparatus being associated with the grating belt, especially the two deflecting shafts or knife edges, are preferably arranged within the length of the tub. This also applies to detailer shafts and other shafts being located at the exit side of the grating belt with respect to the apparatus. The tub is designed to be longer than all these elements such that mass dripping down from the grating belt or from these elements is directly collected by and accumulated in the tub. The apparatus does not need to include stationary elements in addition to the tub such as declined drainage plates. The frame of the apparatus is not located in the inside of the apparatus, but instead at the outside of the apparatus such that it is located at a distance to the other elements of the apparatus and to surround the apparatus in this way. The frame is designed such that there is greater distance and increased free space between its columns in the working direction. In this way, it is possible to fully remove the tub from below the apparatus in a lateral direction. It is not desired to arrange stops limiting the capability of removing the tub. Instead, it is desired that the tub can not only be moved away from the apparatus in a lateral direction to a limited extent, but rather to be completely removed from the apparatus. In this way, it is especially possible to transport the tub to a different location, for example a cleaning room, in which the tub and the components connected thereto may be cleaned in an easier and more reliable way compared to the production location.

At the same time, one attains the possibility of alternately using a plurality of different tubs in the apparatus which may be useful and timesaving when the mass is to be changed, for example. The grating belt remains located in the apparatus and at the frame, respectively. Complete removal of the tub allows for very good access to the grating belt. This especially applies to the upper portion of the grating belt. A plurality of deflecting rollers and tensioning rollers may be arranged in the region of the upper portion of the grating belt. During operation of the apparatus, coating mass drips or drops down onto these rollers, and it accumulates on these rollers. The novel design of the apparatus reduces the required time for cleaning and maintaining the above mentioned elements of the apparatus. Hygiene requirements can be better fulfilled since accessibility of the elements and cleaning conditions are improved. Due to the design and arrangement of the tub and its associated elements as a tub unit, there is the possibility during manufacture of such a novel apparatus to complete assemble the tub unit and to handle it as a unit, especially to suspend it at the frame, or simply to freely move it below the frame in a lateral direction. For this purpose, it is sufficient to arrange the tub unit on wheels such that it is freely movable it may be preferred to fixedly connect the tub unit to the apparatus below the apparatus, but this is not required in many cases.

It is especially preferred if the tub unit at least includes the pump for circulation of the mass, the rising tube and the coating unit or at least a part of the coating unit. The present invention also relates to such a novel tub unit. During the above explained preparing services and other services or a change of the coating mass, it is no longer necessary to operate such elements as rapid connections located at the rising tube and to take the necessary steps against further dripping of the remainder of the mass. The rising tube does not have to be opened. Remaining mass dripping down from the coating unit simply and securely enters the tub even when the tub has been removed from the apparatus. The ground on which the apparatus is placed does not have to be cleaned. In many cases, it is sufficient to only arrange a part of the coating unit at the tub unit. This especially applies to the coating box or a distributing tube, while, for example, a distributing plate being arranged downstream of the distributing tube may be arranged in the apparatus in a stationary manner, whereas the tub unit is moved away from the apparatus in a lateral direction.

Each of the tub unit, the grating belt unit with its support and its drive as well as the electric supply and control elements may be designed as a separate mountable unit to be separately assembled in the frame. Such a design substantially reduces assembly times of the novel apparatus. All units may be separately and especially simultaneously produced. These units are then arranged in and connected to the frame one after the other. Manufacture and assembly times are respectively reduced since the step producing the separate units may work simultaneously without problem.

The design of the frame of the novel apparatus substantially differs from known constructions of frames of known apparatuses for coating articles. The frame is no longer located in the inside of the apparatus in a way to be partly covered by cover plates, but it instead surrounds the other units of the apparatus with a respective distance thereto. In a horizontal sectional view, the cross-sections of the columns are located outside of the surface resulting from the length and the width of the grating belt unit and the tub unit being located below the grating belt unit. The frame also is a significant design element such that the apparatus also is novel in an aesthetic sense.

The grating belt unit forms a unit which may be separately handled. The grating belt unit preferably includes at least the grating belt, the deflecting shafts, the side walls and the support of the shafts and of the driving elements. In case the grating belt includes additional elements such as a detailer shaft or other shafts, for example, these preferably are also part of the grating belt unit.

These shafts are also supported in the side walls. Since the tub with its horizontal surface has a greater surface than the grating belt unit, one does not only attain the advantage of all mass dripping or dropping down from the grating belt and its elements being collected by the tub during normal production. Usually, the tub includes a heating unit to apply heat, especially in an upward direction, such that elements of the grating belt unit are reached. Due to this heat, dripping of the mass down from the elements of the grating belt is improved and the remainder of the mass located on the grating belt is reduced, respectively.

A protrusion which is circumferentially opened in an outward direction is located in one of the sides of the grating belt unit. The protrusion or recess serves to allow for arrangement of the rising tube. The protrusion extends in the direction in which the tub is removed such that the tub unit can be removed together with the rising tube without having to detach or open rapid connections and the like. At the same time, dripping of coating mass down from the rising tube and/or from the coating unit onto the ground is prevented. Dripping down mass securely drips into the tub.

The tub unit may also include a plurality of additional elements and features, respectively. The entire tube may be designed to include two walls. A heating unit, especially one using warm water, may also be arranged at the tub unit, and it may be connected to the interior between the two walls of the tub. The pump serving for circulation of the mass as well as the return pump serving to convey surplus mass into a mass container, especially one including a decrystallization unit, may also be part of the tub unit. The coating unit including a distributing plate may be part of the tub unit. It is sufficient to arrange the tub unit on wheels to be freely movable. However, it is also possible to move the tub unit on rails. Movability of the tub unit is chosen in a way that the tub unit may be completely removed from the frame to especially allow for access to the stationary grating belt unit from the free side.

There are a number of different possibilities of designing the frame being located in an outside portion of the apparatus. It is possible to connect each pair of columns of the frame in an upper portion by a transverse carrier extending approximately transverse with respect to the working direction of the apparatus, meaning the direction in which the articles are transported through the apparatus. In other words, there is a partial frame at the entrance of the apparatus and another partial frame at the exit of the apparatus, both partial frames having the shape of an inverted U. These two U-shaped frames are stiffened by the grating belt unit and the supply and control units which are assembled and supported at the two U-shaped partial frames. The support is especially realized by using consoles. In case of such a design of the frame, it is possible to design the tub in a way that it has a greater horizontal surface than the grating belt unit and to be nonetheless removable from the apparatus in a lateral direction to be completely removed from the apparatus. The use of consoles results in a distance of the vertical columns being realized in two directions. One of the directions serves for removal of the tub unit. The other direction serves to easily connect transportation belts at the entrance and at the exit of the grating belt unit of the apparatus.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a perspective view of the novel apparatus.

FIG. 2 is a side view of the novel apparatus.

FIG. 3 is a front view of the novel apparatus.

FIG. 4 is a detailed view of the tub unit and the grating belt unit of the novel apparatus.

FIG. 5 is a schematic front view of the novel apparatus.

FIG. 6 is a schematic horizontal sectional view along line VI-VI in FIG. 5.

### DETAILED DESCRIPTION

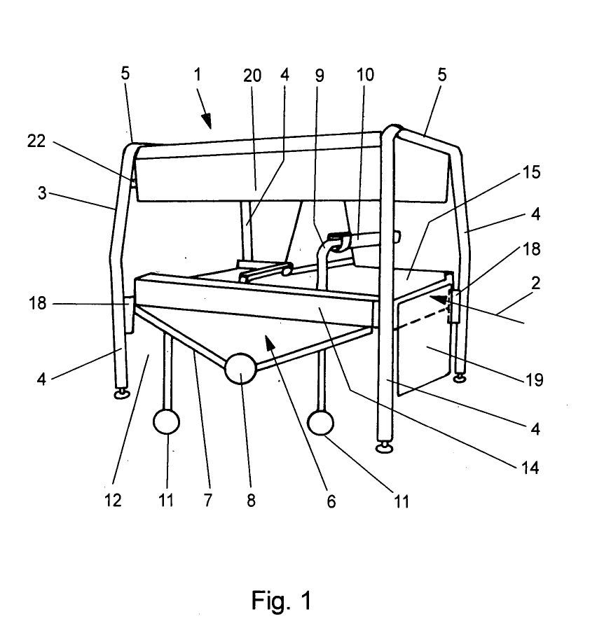

Referring now in greater detail to the drawings, FIG. 1 illustrates a preferred exemplary embodiment of the novel apparatus 100. However, other designs of the novel apparatus 1 are also possible. Usually, the apparatus 1 is designed such that its length is greater than its width. The longer side of the apparatus 1 extends in the working direction 2 indicated by an arrow. The working direction 2 of the apparatus 1 is defined by the direction of movement of a grating belt 15 through the apparatus 1. Articles to be coated with the coating mass are placed on the grating belt 15 in a way that they are transported through the apparatus 1 in the working direction 2. The apparatus 1 includes a frame 3 and additional components which will be explained in greater detail herein below. The frame 3 includes two mirror-symmetric elements or partial frames of which one is arranged at the entrance side of the apparatus 1 and the other is arranged at the exit side of the apparatus 1. Each of these elements or partial frames includes two substantially vertical columns 4. The columns 4 may be designed to extend in an approximately vertical direction, or to be slightly declined with respect to the vertical direction. In the exemplary embodiment of the frame 3 as illustrated in FIG. 1, the lower portions of the columns 4 extend in an approximately vertical direction, whereas the upper portions of the vertical columns 4 are designed to be slightly inclined and declined, respectively, in two directions. At the entrance side of the apparatus 1, the two columns 4 at their upper ends are interconnected by a transverse carrier 5 such that the partial frame attains an inverted U shaped design. The same applies to the partial frame located at the exit side of the apparatus 1. The frame 3 with its elements is designed and arranged in a way that it is located outside of the remaining components of the apparatus 1, and that these components are located within the frame 3, respectively.

In the interior surrounded by the frame 3, the apparatus 1 includes the following elements, as they will be mentioned in the order beginning at the bottom portion and continuing in an upward direction: The apparatus 1 includes a tub unit 6 including a tub 7 and a pump 8. The pump 8 serves to suck in coating mass accumulating in the tub 7. The coating mass then flows through a rising pipe 9 ending in coating units 10 from which a curtain of coating mass (not illustrated) flows down in a perpendicular direction due to gravity. The tub unit 6 may include additional components, as for example a recirculation pump for surplus chocolate mass or a heating unit by which the tub 7 may be heated. Usually, the tub 7 is designed to include two spaced apart walls through which a heating medium flows which circulates in a heating circuit, preferably a warm water circuit. The tub 7 and the tub unit 6, respectively, are designed to be movable by means of wheels 11. The direction of movement is perpendicular with respect to the working direction 2 of the apparatus 1 such that the tub 7 and the tub unit 6, respectively, are moved away from the apparatus 1 in a lateral direction. Instead of simply rolling on the ground on which the apparatus 1 is supported, the wheels 11 may also be guided in rails. To be capable of moving the tub unit 6 within the frame 3 and to remove it from the apparatus 1, the length of the tub unit 6 as measured in the working direction 2 is chosen to be less than the distance between the two columns 4 of the frame 3 being located at one side of the apparatus 1, meaning one column 4 arranged in the front portion and the associated column 4 being located in the rear portion of the apparatus 1 as illustrated in FIG. 1. The tub unit 6 may be removed from below the apparatus 1 in a lateral direction such that it is freely accessible. The apparatus 1 includes a respective free space 12 having a length and a height such that the tub unit 6 may be removed from below the apparatus 1.

A grating belt unit 13 is arranged above the tub unit 6. The grating belt unit 13 includes two side pieces 14 extending in the longitudinal direction, meaning in the working direction 2 of the apparatus 1. The grating belt 15 is driven to circulate between the side pieces 14 in the working direction 2. The products and articles, respectively, to be coated by a coating mass are placed on the grating belt 15. The products are guided and transported through the apparatus 1 by the driven grating belt 15. During their movement, the products pass through the downwardly flowing curtain of coating mass such that they are coated. The grating belt 15 includes an upper portion 16 and a lower portion 17. It is to be understood that the grating belt 15 with its upper portion and the lower portion 17 is guided and supported by a plurality of deflecting rollers and supporting rollers being supported in the side pieces 14 of the grating belt unit 13. The drive for the grating belt 15 is also arranged in this portion. The deflecting rollers and driving rollers for the grating belt 15 are only schematically illustrated since the design is known in the art. Consoles 18 are arranged at the vertical columns 4 to support the grating belt unit 13, the consoles 18 being arranged at an inclined orientation. The grating belt unit 13 may be assembled as a unit which is then connected to the frame 3 of the apparatus 1 in a way to be fixed by the consoles 18.

In its lower portion, meaning below the grating belt unit 13 in which the tub unit 6 is arranged, the apparatus 1 may include covering elements 19. An example of such a covering element 19 is illustrated at the entrance side of the apparatus 1. It is to be understood that the covering elements 19 may be located in the lower portion of the apparatus 1 at all four sides of the apparatus 1. The covering elements 19 located at both longitudinal sides of the apparatus 1 may be designed to be pivotable and to be removable, respectively, for example, to allow for lateral removal of the tub unit 6 from below the apparatus 1.

A control and supply unit 20 is arranged in the upper portion of the apparatus 1 and of the frame 3, respectively. The control and supply unit 20 includes electric elements serving to supply and control the elements of the apparatus 1 with power. A fan is also located in the region of the control and supply unit 20. The fan sucks in air, and it blows the air towards and onto the freshly coated articles via a nozzle 21. The air serves to uniformly distribute the coating and to reduce the thickness of the coating. Surplus mass is blown off from the articles, and it reaches the upper portion 16 of the grating belt 15, and it is protrudes through the grating belt 15, respectively, such that it reaches the tub 7 of the tub unit 6. The same applies to surplus mass of the curtain of coating mass which is located outside of the path of the products. The frame 3 and the vertical columns 4, respectively, also include consoles 22 in this upper portion serving to support the control and supply unit 20.

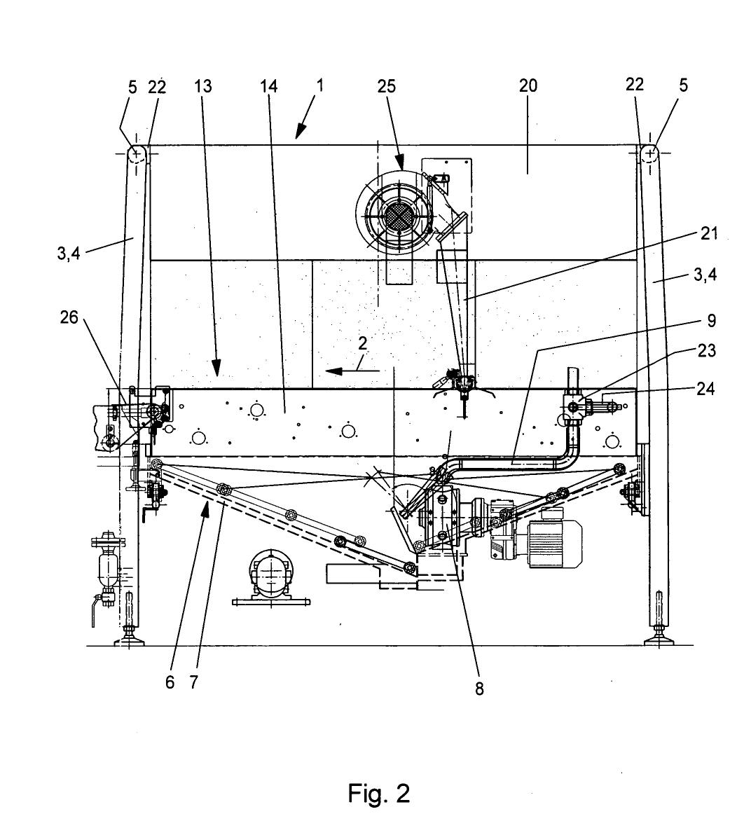

FIG. 2 is a side view of the novel apparatus 1 showing additional constructive details of the apparatus 1. The tub unit 6 including the tub 7 having two walls, and the pump 8 is located in the lower portion of the apparatus 1 between the columns 4 of the frame 3. The rising tube 9 may include a junction 23 via which the branching-off tube 24 leads to a bottoming unit (not illustrated) serving to coat the bottom surfaces of the product pieces.

The grating belt unit 13 with the side pieces 14 is arranged above the upper rim of the tub 7. FIG. 2 generally also shows support and arrangement of the deflecting rollers and of the tensioning rollers.

FIG. 2 also illustrates a fan 25 being located in the control and supply unit 20. The fan 25 delivers air to the nozzle 21 which freely ends at a respective distance above the upper portion 16 of the grating belt 15.

A conveying belt 26 is schematically illustrated in FIG. 2 at the exit side of the apparatus 1. The conveying belt 26 serves to transport the coated articles coming form the grating belt 15, and to further convey them into and through, respectively, a cooling channel (not illustrated), for example, or other apparatuses.

The upper part between the control and supply unit 20 and the upper portion 16 of the grating belt 15 are also designed such that they may be covered. The flaps 27 serve for this purpose. Preferably, the flaps 27 are made of transparent plastic material to be capable of observing correct operation of the apparatus 1.

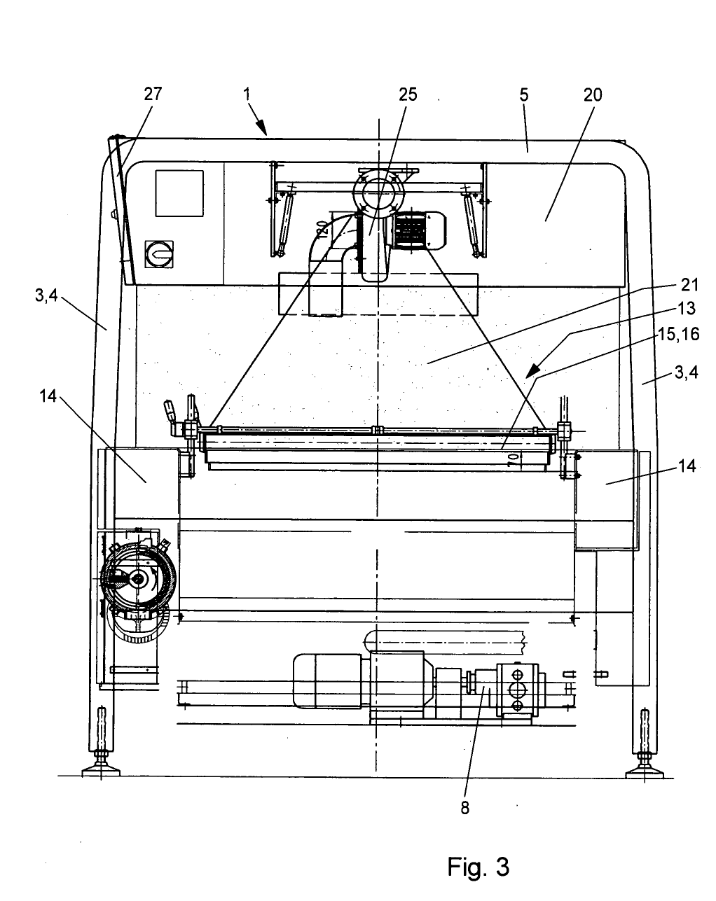

FIG. 3 is a front view of the novel apparatus 1 showing additional details.

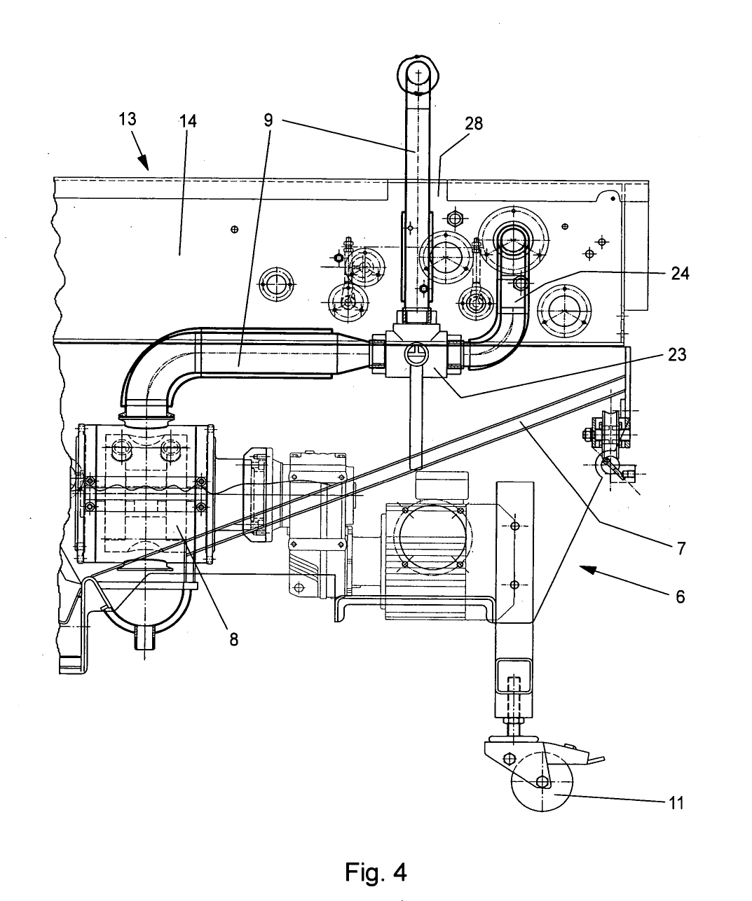

FIG. 4 is a detailed view of the grating belt unit 13 and of the tub unit 6 being arranged below it. It is also to be seen in FIG. 4 that a circumferentially opened protrusion 28 is located in one of the side pieces 14 through which the rising tube 9 protrudes from below in an upward direction.

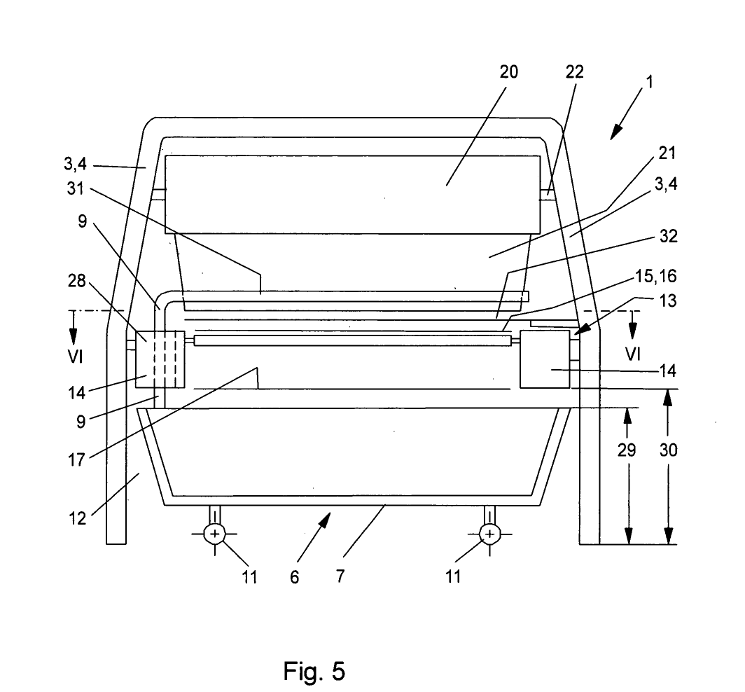

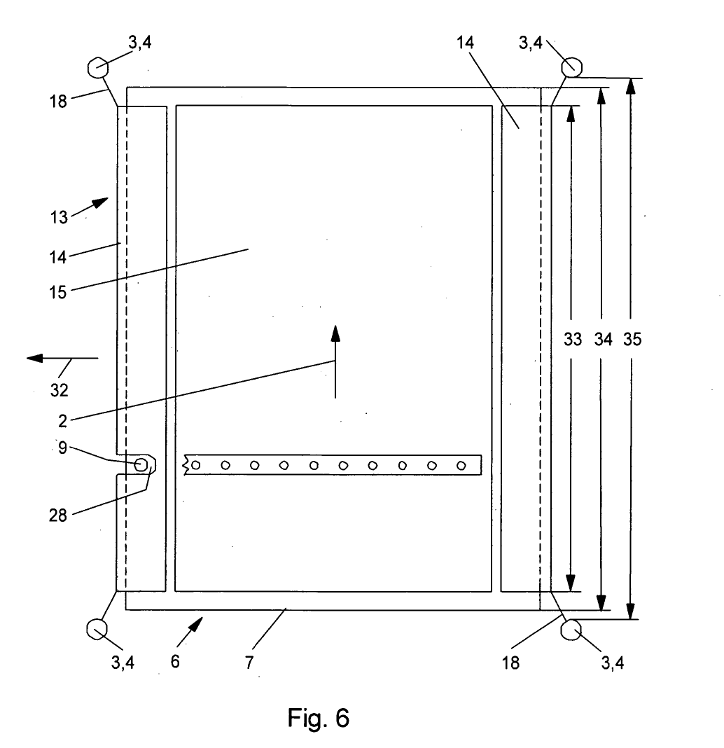

FIGS. 5 and 6 again illustrate the design and arrangement of the components of the apparatus 1 with respect to the vertical columns 4 of the frame 3. FIG. 5 illustrates the free space 12 between the front and rear columns 4 and the tub 7 of the tub unit 6 being located therebetween. The tub unit 6 has a height 29 which is smaller than the distance 30 of the lower rim of the grating belt unit 13. It is also to be seen from FIG. 5 that the tub 7 has a design in this direction such that coating mass dripping down from components of the grating belt unit 13 is collected in the tub 7. It is also to be seen in FIG. 5 that the circumferentially opened protrusion 28 is located in one of the side pieces 14, the rising tube 9 of the tub unit 6 protruding through the protrusion 28 in an upward direction. The rising tube 9 ends in a distributing tube 31 which is part of the coating unit 10. A distributing plate 32 may also be part of the coating unit 10, the plate 32 being supported at the frame 3 in a stationary manner. Instead, it could be supported at the distributing tube 31 such that it is part of the tub unit 6.

FIG. 6 clearly illustrates the arrangement of the components of the apparatus 1 being located in the area defined by the vertical columns 4 of the frame 3. The grating belt unit 13 with its side walls 14 is connected to the transverse consoles 18. The grating belt unit 13 has a length 33. The tub unit 6 with its tub 7 located below the grating belt unit 13 has a length 34. The vertical columns 4 in this region are located at a distance 35. It is to be seen in FIG. 6 that the length 34 is greater than the length 33 and smaller than the distance 35. In this way, one makes sure that all coating mass dripping down from the grating belt unit 13 reaches the tub 7, and that the tub 7 may nevertheless be moved out off and away from the frame 3 in a lateral direction. This movement of the tub unit 6 occurs in the direction of arrow 36, meaning in a direction perpendicular with respect to the working direction 2.

Due to the transverse or inclined arrangement of the consoles 18 and free arrangement of the vertical columns 4 in an outer region of the apparatus 1, one simultaneously achieves the possibility of arranging conveying belts at the entrance side and at the exit side of the apparatus 1 close to the deflecting locations of the grating belt 15.

Many variations and modifications may be made to the preferred embodiments of the invention without departing substantially from the spirit and principles of the invention. All such modifications and variations are intended to be included herein within the scope of the present invention, as defined by the following claims.

We claim:

1. An apparatus for coating edible products with a fat-containing coating mass, comprising:
a frame, said frame including a plurality of spaced apart columns, said columns being located in an outer portion of said apparatus and being designed and arranged to be approximately vertical;
a grating belt, said grating belt being designed and arranged to transport the products placed thereon though said apparatus in a working direction;
a coating unit, said coating unit being designed and arranged such that the coating mass is directed onto the products as they are transported on said grating belt though said apparatus; and
a tub unit,
said tub unit including a tub having a length in the working direction and a height,
the length of said tub being chosen such that essentially all surplus coating mass dripping down from said grating belt is collected in said tub,
the height of said tub being chosen such that said tub fits below said grating belt,
said tub and said columns being designed and arranged such that a distance between said columns in the working direction is greater than the length of said tub such that said tub can be completely removed from said apparatus in a lateral direction perpendicular to the working direction.

2. The apparatus of claim 1, further comprising:
a pump, said pump being located in a lower region of said tub such that said pump can suck in coating mass contained in said tub; and
a rising tube, said rising tube having a lower end and an upper end, the lower end being connected to said pump and the upper end being connected to said coating unit such that coating mass contained in said tub can be transferred into said coating unit and onto the articles to be coated.

3. The apparatus of claim 2, wherein said tub unit includes said pump, said rising tube and said coating unit.

4. The apparatus of claim 3, further comprising a grating belt unit, said grating belt unit including said grating belt, a support, a drive and electric control and supply elements, said grating belt unit being designed as a unit separate from said tub unit such that said grating belt unit and said tub unit can be individually mounted to said frame.

5. The apparatus of claim 4, wherein
said grating belt unit has a length and a width,
said tub unit has a length and a width, and
said frame includes at least four columns,
a first associated pair of said columns being arranged at a distance in the working direction which is greater that the length of said grating belt unit and the length of said tub unit, and
a second associated pair of said columns being arranged at a distance perpendicular to the working direction which is greater that the width of said grating belt unit and the width of said tub unit.

6. The apparatus of claim 4, wherein said grating belt unit further includes a plurality of deflecting shafts, a plurality of side walls being designed and arranged to support said grating belt and a plurality of driving elements being designed and arranged to drive said grating belt.

7. The apparatus of claim 5, wherein said grating belt unit further includes a plurality of deflecting shafts, a plurality of side walls being designed and arranged to support said grating belt and a plurality of driving elements being designed and arranged to drive said grating belt.

8. The apparatus of claim 7, wherein one of said side walls includes a protrusion, said protrusion being designed and arranged to be circumferentially opened in an outward direction and to allow for arrangement of said rising tube.

9. The apparatus of claim 1, wherein
said tub is designed to include two spaced apart walls, and
said tub unit further includes a heating unit, said heating unit being designed and arranged to direct a heating medium though the space between said two walls.

10. The apparatus of claim 1, wherein said tub unit includes a plurality of wheels, said wheels being designed and arranged to allow for free movement of said tub unit.

11. The apparatus of claim 5, wherein
said first pair of columns in an upper portion is interconnected by a first transverse carrier, said first transverse carrier extending in a direction transverse with respect to the working direction,
said second pair of columns in an upper portion is interconnected by a second transverse carrier, said second transverse carrier extending in a direction transverse with respect to the working direction.

12. The apparatus of claim 4, wherein said frame further includes a plurality of consoles, said consoles being designed and arranged to support said grating belt unit and said control and supply unit.
